(19) United States
(12) Patent Application Publication
(10) Pub. No.: US 2022/0116841 A1
(43) Pub. Date: Apr. 14, 2022

(54) CONDITIONAL HANDOVER FOR RELAY AND REMOTE UES IN UE-TO-NETWORK RELAY SYSTEM

(71) Applicant: MEDIATEK SINGAPORE PTE. LTD., Singapore (SG)

(72) Inventors: Nathan Edward Tenny, San Jose, CA (US); Chun-Fan Tsai, Hsinchu (TW)

(73) Assignee: MEDIATEK SINGAPORE PTE. LTD., Singapore (SG)

(21) Appl. No.: 17/470,580

(22) Filed: Sep. 9, 2021

Related U.S. Application Data
(60) Provisional application No. 63/090,308, filed on Oct. 12, 2020.

(51) Int. Cl. H04W 36/08; H04W 36/00

(52) U.S. Cl. CPC H04W 36/08; H04W 88/04; H04W 36/0009

(57) ABSTRACT

A method of handing over a remote user equipment (UE) and a relay UE in a UE-to-network relay system includes receiving, at the remote UE from a source base station via a relay UE, a first message including a first handover configuration of a first target base station in the UE-to-network relay system, receiving, at the remote UE from the relay UE, an indication for triggering a conditional handover at the remote UE, and applying, at the remote UE, the first handover configuration of the first target base station in response to the reception of the indication for triggering the conditional handover at the remote UE.

### INCORPORATION BY REFERENCE

This present application laims the benefit of U.S. Provisional Application No. 63/090,308, “Conditional Handover for Relay and Remote UEs in a Layer 2 UE-to-Network Relaying Architecture”, filed on Oct. 12, 2020, which is incorporated herein by reference in its entirety.

### TECHNICAL FIELD

The present disclosure relates to wireless communications and specifically relates to UE-to-network relay enhancement.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In a UE-to-network relay system, a relay user equipment (UE) relays the traffic between a remote UE and a network. The UE-to-network relay enables coverage extension and power saving for the remote UE. A group of remote UEs can rely on an individual relay UE to communicate with a network.

### SUMMARY

Aspects of the disclosure provide a method of handing over a remote user equipment (UE) and a relay UE in a UE-to-network relay system. The method can include receiving, at the remote UE from a source base station via a relay UE, a first message including a first handover configuration of a first target base station in the UE-to-network relay system, receiving, at the remote UE from the relay UE, an indication for triggering a conditional handover at the remote UE, and applying, at the remote UE, the first handover configuration of the first target base station in response to the reception of the indication for triggering the conditional handover at the remote UE.

In an embodiment, the first message further includes a condition for triggering the conditional handover at the remote UE, the condition being the reception of the indication for triggering the conditional handover at the remote UE. An embodiment of the method can further include determining the condition for triggering the conditional handover at the remote UE is satisfied based on the reception of the indication for triggering the conditional handover at the remote UE.

In an embodiment, the indication for triggering the conditional handover at the remote UE is transmitted from the relay UE after the relay UE transmits an indication of handover completion of the relay UE to the first target base station.

In an embodiment, the method further includes transmitting, from the remote UE to the first target base station via the relay UE, a second message including an indication of handover completion by the remote UE. In an embodiment, the method further includes transmitting, from the remote UE to the source base station via the relay UE, a third message acknowledging the reception of the first message.

In an embodiment, the indication for triggering the conditional handover at the remote UE is via a broadcast transmission, a multicast transmission, or a unicast transmission from the relay UE. In an embodiment, the first message includes a plurality of handover configurations each associated with one of a plurality of target base stations including the first target base station.

In an embodiment, the method further includes receiving, from the relay UE, an indication of which one of the plurality of handover configurations is to be applied for the conditional handover at the remote UE. In an embodiment, the indication of which one of the plurality of handover configurations is to be applied for the conditional handover at the remote UE includes an identifier corresponding to a cell of the first target base station.

Aspects of the disclosure provide another method of handing over a UE and a relay UE in a UE-to-network relay system. The method can include receiving a first message including a first handover configuration of a first target base station from a source base station at a relay UE in a UE-to-network relay system, performing a handover process at the relay UE to apply the first handover configuration and access the first target base station, and transmitting an indication of handover completion of the relay UE to a remote UE from the relay UE to trigger a conditional handover at the remote UE after the relay UE completes the handover process.

In an embodiment, the indication of handover completion of the relay UE is transmitted from the relay UE after the relay UE transmits an indication of handover completion of the relay UE to the first target base station. In an embodiment, the handover process of the relay UE is triggered by the reception of the first handover configuration of the first target base station from the source base station.

In an embodiment, the first message further include a first execution condition associated with the first handover configuration of the first target base station, and the handover process of the relay UE is a conditional handover that is triggered when the relay UE determines that the first execution condition has been satisfied. An embodiment of the method can further include transmitting, to the remote UE, an indication of which cell or base station the relay UE is handed over to.

In an embodiment, the method can further include stopping a forwarding process for relayed communications between the remote UE and the source base station when the handover process to apply the first handover configuration and access the first target base station is triggered, and resuming the forwarding process for relayed communications between the remote UE and the source base station when the relay UE completes the handover process.

In an embodiment, the method can further include relaying, at the relay UE from the source base station to the remote UE, a second message including a second handover configuration of the first target base station for the remote UE, and relaying, at the relay UE from the remote UE to the first target base station, a third message including an indication of handover completion of the remote UE based on the second handover configuration of the first target base station. In an embodiment, the second message further includes a condition for triggering the conditional handover at the remote UE, the condition being a reception of the indication of handover completion of the relay UE at the remote UE.

In an example, the relay UE receives the first message including the first handover configuration of the first target base station for the relay UE after the relay of the second message including the second handover configuration of the first target base station. In another example, a grouped handover command can be received at the relay UE from the source base station. The grouped handover command can include the first message including the first handover configuration of the first target base station for the relay UE, and the second message including the second handover configuration of the first target base station for the remote UE.

An embodiment of the method can further include receiving a conditional handover command in the first message from the source base station at the relay UE. The conditional handover command can include a plurality of third handover configurations including the first handover configuration of the first target base station for the relay UE. The plurality of third handover configurations each correspond to one of a plurality of candidate target base stations including the first target base station. The plurality of third handover configurations can each be associated with one or more conditions for triggering the relay UE to apply the respective third handover configuration. The second message includes a plurality of fourth handover configurations each corresponding to one of the plurality of candidate target base stations. The plurality of fourth handover configurations includes the second handover configuration of the first target base station for the remote UE.

An embodiment of the method can further include determining, at the relay UE, one of the one or more conditions associated with one of the plurality of third handover configurations corresponding to the first target base station is satisfied, and transmitting, to the remote UE, an indication indicating that, among the plurality of fourth handover configurations, the fourth handover configuration corresponding to the first target base station is to be applied for the conditional handover at the remote UE.

Aspects of the disclosure further provide another method of handing over a UE and a relay UE in a UE-to-network relay system. The method can include receiving, at a relay UE from a source base station in the UE-to-network relay system, a message. The message can include a first conditional handover configuration of a first candidate target base station for the relay UE, a first condition for applying the first conditional handover configuration of the first candidate target base station at the relay UE, and a first remote UE handover configuration of the first candidate target base station for a remote UE. The method can further include determining the first condition for applying the first conditional handover configuration of the first candidate target base station at the relay UE is satisfied, and transmitting, from the relay UE to the remote UE, the first remote UE handover configuration of the first candidate target base station.

An embodiment of the disclosure can further include stopping, subsequent to the determination of the first condition for applying the first conditional handover configuration of the first candidate target base station at the relay UE being satisfied, a forwarding process between the remote UE and the source base station. The transmission of the first remote UE handover configuration of the first candidate target base station is performed after the forwarding process between the remote UE and the source base station being stopped.

An embodiment of the disclosure can further include transmitting, from the relay UE to the first candidate target base station, an indication of a conditional handover being completed by the relay UE. The transmission of the first remote UE handover configuration of the first candidate target base station is performed after the transmission of the indication of the conditional handover being completed by the relay UE.

In an embodiment, the first remote UE handover configuration of the first candidate target base station for the remote UE is carried in a container field of the received message. An embodiment of the disclosure can further include relaying an indication of handover completion from the remote UE to the first candidate target base station.

In an embodiment, the message includes a plurality of conditional handover configurations each corresponding to one of a plurality of candidate target base stations for the relay UE, the plurality of conditional handover configurations including the first conditional handover configuration, the plurality of candidate target base stations including the first candidate target base station. The message further include a plurality of conditions each for applying a respective one of the plurality of conditional handover configuration at the relay UE, the plurality of conditions including the first condition for applying the first conditional handover configuration of the first candidate target base station at the relay UE, and a plurality of remote UE handover configurations each corresponding to one of the plurality of candidate target base stations for the remote UE, the plurality of remote UE handover configurations including the first remote UE handover configuration.

An embodiment of the disclosure can further include identifying the first remote UE handover configuration from the plurality of remote UE handover configurations based on a cell ID corresponding to the first candidate target base station, the first condition for applying the first conditional handover configuration of the first candidate target base station at the relay UE being determined to be satisfied.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a UE-to-network relay system 100 according to an embodiment of the disclosure.

FIG. 2 shows a remote UE and relay UE handover process 200 according to an embodiment of the disclosure.

FIG. 3 shows another remote UE and relay UE handover process 300 according to an embodiment of the disclosure.

FIG. 4 shows another remote UE and relay UE handover process 400 according to an embodiment of the disclosure.

FIG. 5 shows another remote UE and relay UE handover process 500 according to an embodiment of the disclosure.

FIG. 6 shows a handover process 600 according to an embodiment of the disclosure.

FIG. 7 shows a handover process 700 according to an embodiment of the disclosure.

FIG. 8 shows a handover process 800 according to an embodiment of the disclosure.

FIG. 9 shows an exemplary apparatus 900 according to embodiments of the disclosure.

### DETAILED DESCRIPTION OF EMBODIMENTS

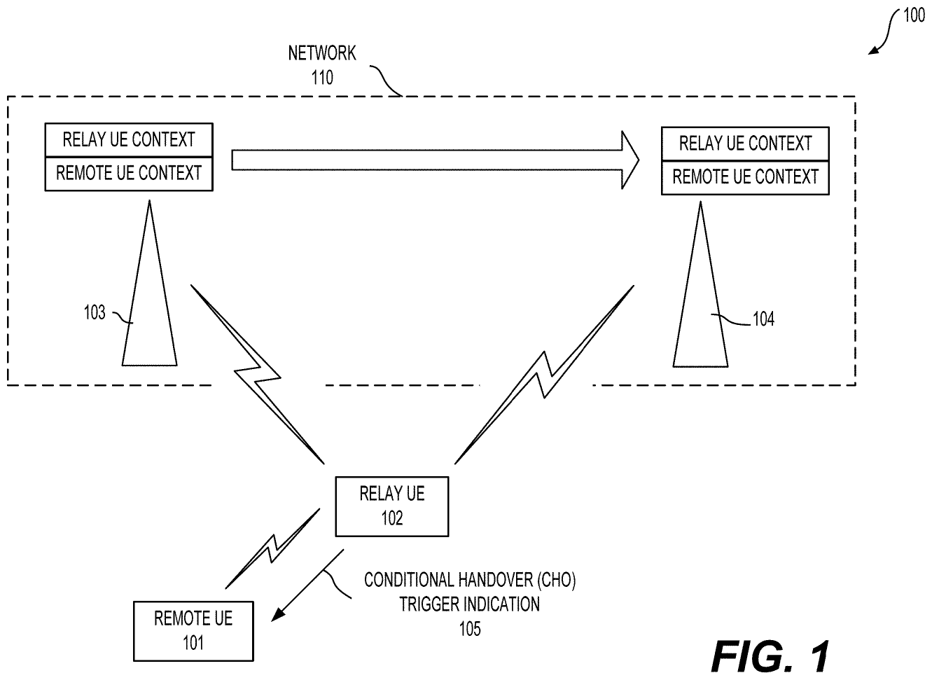

FIG. 1 shows a UE-to-network relay system 100 according to an embodiment of the disclosure. The system 100 can include a remote user equipment (UE) 101, a relay UE 102, and a network 110. The relay UE 102 forwards data traffic between the remote UE 101 and the network 110. The network 110 can include a first base station 103 and a second base station 104.

Initially, the relay UE 102 can be connected with the first base station 103. A relay UE context is maintained at the first base station 103. Later, the relay UE 102 can move away from the first base station 103 and approach the second base station 104. A handover of the relay UE 102 from the base station 103 to the base station 104 accordingly takes place. During this handover process, the first base station 103 is a source base station 103, while the second base station 104 is a target base station 104. A relay UE context is established at the target base station 104.

In an embodiment, accompanying the relay UE 102 being handed over from the source base station 103 to the target base station 104, a series of handover related operations can take place to hand over the remote UE 101 (or other remote UEs if exist) to the target base station 104. Service continuity between the remote UE 101 and the network 110 via the relay UE 102 can be maintained for the remote UE 101 while the remote UE 101 is being handed over.

Before the handover of the remote UE 101, a remote UE context can be maintained at the source base station 103 for the remote UE 101. The remote UE context may be associated with the relay UE context in the source base station 103. During the handover of the remote UE 101, a remote UE context can be established at the target base station 104 for the remote UE 101 during a handover preparation process.

Also, during or before the handover of the relay UE 102, a handover configuration can be signaled from the source base station 103 to the remote UE 101. Later, a handover of the remote UE 101 can be triggered. The handover configuration can be applied (or executed) by the remote UE 101. An indication of the completion of the application or execution of the configuration can be reported to the target base station 104. In response, data paths for the remote UE 101 can be transferred within the network 110 from the source base station 103 to the target base station 104.

In some embodiments, a conditional handover (CHO) mechanism can be employed for handling handover of the remote UE 101 in the UE-to-network relay system 100. The CHO mechanism can effectively solve a timing issue that the handover completion indication of the remote UE 101, intended for the target base station 104, is transmitted earlier than desired, leading to a handover completion message or other traffic intended for the target base station 104 being relayed by the relay UE 102 to the unintended source base station 103.

For example, a CHO configuration can be transmitted from the source base station 103 to the remote UE 101 via the relay UE 102 before the handover of the relay UE 102. The CHO configuration can include a configuration of a target base station (the target base station 104 in the FIG. 1 example) for the remote UE 101 and a condition for triggering execution of the handover configuration. The condition can be the arrival of a trigger indication 105 transmitted from the relay UE 102. By controlling the timing of transmitting the trigger indication 105, the timing of the handover of the remote UE 101 can be controlled.

In an embodiment, the relay UE 102 can be configured to send the trigger indication 105 after the handover of the relay UE 102 is successful. The success of the handover of the relay UE 102 can be indicated by a handover completion message being sent from the relay UE 102 to the target base station 104, for example. As a result, the handover completion message from the remote UE 101 can be ensured to be relayed to the target base station 104 instead of the source base station 103.

While only one remote UE 101 is shown in FIG. 1, a group of remote UEs can connect with the relay UE 102 and rely on the relay service provided by the relay UE 102. When the relay UE 102 performs a handover from a source base station to a target base station, the group of remote UEs can follow the relay UE 102 to hand over to the same target base station. The handover related techniques, such as the CHO mechanism in the context of the UE-to-network relay disclosed herein, can similarly be used for handover of the group of remote UEs.

The relay UE 102 and the remote UE 101 can each be a mobile phone, a laptop, a tablet computer, a vehicle, a wearable device, or the like, in various embodiments. The network 110 can be implemented with various wireless communication technologies, such as third-generation (3G), fourth-generation (4G), or fifth-generation (5G) technologies. For example, the base station 103 or 104 can implement a gNB as specified by the New Radio standards developed by The Third Generation Partnership Project (3GPP), or an eNB as specified by the Long Term Evolution (LTE) standards developed by 3GPP. In other examples, the network 110 may employ non-standardized wireless communication technologies. In various embodiments, the source base station 103 and the target base station 104 can be based on a same or different radio access technologies (RATs).

Before the handover, the relay UE 102 relays communications (user data and/or control messages) between the remote UE 101 and the source base station 103. After the handover, the relay UE 102 relays communications (user data and/or control messages) between the remote UE 101 and the target base station 104. The relay operations of user data and/or control messages can be performed in various ways in various embodiments.

In an example, a layer-2 (L2) UE-to-network relay is employed. For example, a set of L2/L3 layer and sublayer protocols in a protocol stack, such as radio resource control (RRC) protocol, service data adaptation protocol (SDAP), and packet data convergence protocol (PDCP), can be terminated between the remote UE 101 and the source base station 103 via the relay UE 102. Data packets generated from the PDCP sublayer (which is below the SDAP or RRC sublayers in the protocol stack) are forwarded at the relay UE 102 but not decoded or inspected by the relay UE 102. It is noted that not all protocol layers may be embodied in a particular protocol stack. For example, a control-plane protocol stack between the remote UE 101 and the source base station 103 may comprise an RRC protocol layer and a PDCP protocol layer, while a user-plane protocol stack between the remote UE 101 and the source base station 103 may comprise an SDAP protocol layer and a PDCP protocol layer.

For example, with the L2 UE-to-network relay mechanism, an RRC control message of the RRC sublayer (or referred to as RRC layer) transmitted from the source base station 103 or the remote UE 101 can arrive at the relay UE 102 being packaged in PDCP packets. The PDCP packets are processed and forwarded by a lower layer(s) (such as a radio link control (RLC) sublayer, a medium access control (MAC) sublayer, or a physical (PHY) sublayer in the protocol stacks). The lower layer(s) may be terminated separately between the remote UE 101 and the relay UE 102, and between the relay UE 102 and the source base station 103. In this way, the RRC control messages between the remote UE 101 and the source base station 103 can pass through the relay UE 102 transparently.

In another example, the relay UE 102 can see arriving control messages but forward them without decoding or knowing the content within the control messages. For example, besides the relay operations, the relay UE 102 can communicate with the base station 103 based on a Uu interface and with the remote UE 101 based on a PC5 interface. A Uu RRC sublayer (or RRC layer) can terminate between the relay UE 102 and the base station 103. A PC5 RRC layer can terminate between the remote UE 101 and the relay UE 102. Accordingly, an RRC control message (referred to as a relay RRC message) from the base station 103 towards the remote UE 101 can first be carried, for example, in a container of a Uu RRC message of the Uu RRC layer and arrive at the relay UE 102.

The relay UE 102 obtains the relay RRC message from the container and forwards the relay RRC message without decoding the relay RRC message. For example, the relay UE 102 does not have the credentials needed for decoding the relay RRC message. Privacy of the remote UE 101 can thus be protected. When being relayed, the relay RRC message can be carried in a container of a PC5 RRC message of the PC5 RRC layer, for example. The PC5 RRC message, as a carrier of the relay RRC message, can be transmitted from the relay UE 102 to the remote UE 101. In the reverse direction, a relay RRC control message can be transmitted from the remote UE 101 to the base station 103 using a container of a carrier message in a similar way.

In a further example, the transmission of a relay control message can still use a container of a layer or sublayer terminated between the base station 103 and the relay UE 102 or between the relay UE 102 and the remote UE 101. Different from the above example, the relay UE 102 can decode the relay control message and forward a portion of the information included in the relay control message. For example, when a relay control message carried in a container and containing an RRC reconfiguration is received at the relay UE 102 from the base station 103, the relay UE 102 can select a portion of that RRC reconfiguration and put it into a container towards the remote UE 101. Which portion to forward can depend on certain conditions.

It is noted that the above examples are described for illustration purposes. Different mechanisms or implementations may be employed in other embodiments or examples to relay user data or control messages between a remote UE and a network to support various handover mechanisms disclosed herein. In addition, various short-range wireless technologies can be employed for communications (including relaying or non-relaying communications) between the remote UE 101 and the relay UE 102. Examples of the short-range communications can include New Radio sidelink as specified by 3GPP standards, LTE sidelink as specified by 3GPP standards, Wi-Fi technologies, or other non-3GPP technologies.

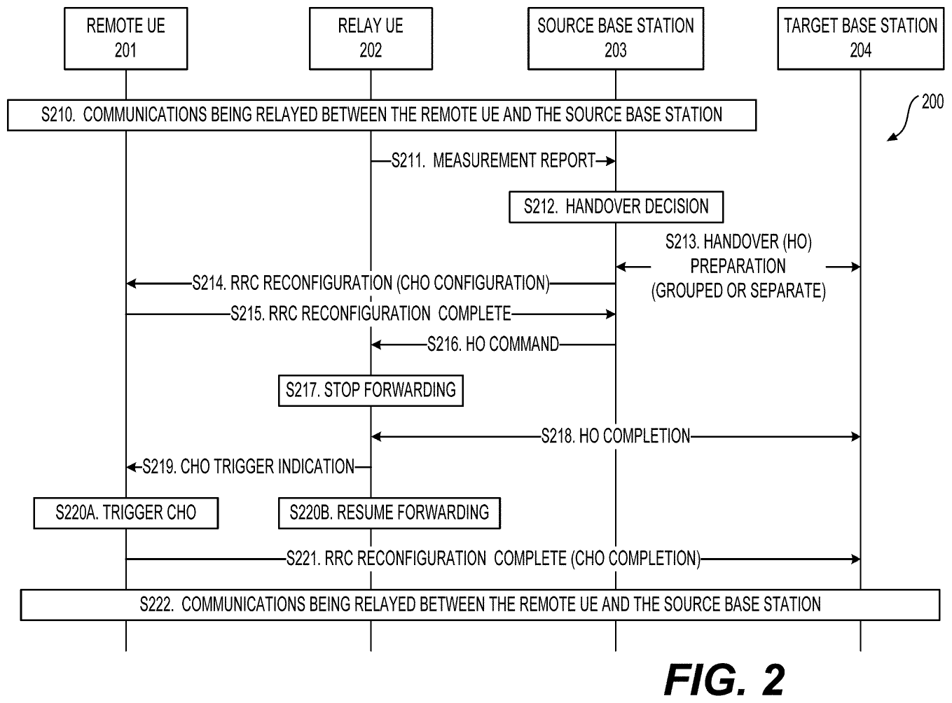

FIG. 2 shows a remote UE and relay UE handover process 200 according to an embodiment of the disclosure. During the process 200, a remote UE 201 and a relay UE 202 are handed over from a source base station 203 to a target base station 204. The handover of the remote UE 201 is triggered by a CHO trigger indication received by the remote UE 201 from the relay UE 202. The process 200 can start from S210.

At S210, communications are being relayed between the remote UE 201 and the source base station via the relay UE 202. For example, user data and/or control messages can be relayed by the relay UE 202 using the L2 UE-to-network relay mechanism or any other suitable relay mechanisms. In addition to the relay operations, non-relay communications between the relay UE 202 and the source base station 203 or between the relay UE 202 and the remote UE 201 can also be performed at S210.

At S211, a measurement report message is transmitted from the relay UE 202 to the source base station 203. For example, the relay UE 202 can periodically measure signal qualities of reference signals transmitted from a serving cell and neighbor cells. The measurement report can be triggered by a predefined event. For example, the event can be when a signal quality of a neighbor cell is better than that of the serving cell by a preconfigured offset. The measurement report can include measurements indicating signal qualities of the serving cell and one or more neighbor cells. Examples of these measurements can include reference signal received power (RSRP), reference signal received quality (RSRQ), signal to interference plus noise ratio (SINR), or the like.

At S212, a handover decision can be made at the source base station 203 based on the measurement report transmitted from the relay UE 202. For example, the target base station 204 can be selected from a set of candidate base stations (or cells) for handing over the relay UE 202 and the remote UE 201 from the source base station 203. In other examples, the handover decision can be made based on factors other than signal qualities, such as for purpose of load balancing.

At S213, a handover preparation process can be performed between the source base station 203 and the target base station 204. For example, the source base station 203 can send a handover request to the target base station 204. In response, the target base station 204 can perform admission control and provide configurations of the target base station 204 for the relay UE 202 and/or the remote UE 201 to the source base station 203. The interaction between the source base station and the target base station 204 can be a direct communication (for example, based on an X1 interface) or via other nodes within the network 110 (for example, based on an S1 interface).

The configurations of the target base station 204 can include a configuration for each of the relay UE 202 and the remote UE 201. If multiple remote UEs are being relayed by the relay UE 202, the configurations of the target base station 204 can include a configuration for every remote UE. Each such configuration can be carried in a RRC layer message. In such a case, the message is referred to as an RRC reconfiguration message.

In some examples, the RRC reconfiguration message can include a cell ID of a target cell of the target base station 204 and information required to access the target cell. In this way, the relay UE 202 and the remote UE 201 can access the target cell without reading system information. In some cases, the information required for contention-based and contention-free random access can also be included in the RRC reconfiguration message. The information for accessing the target cell may also include a new cell radio network temporary identified (C-RNTI), the target base station security algorithm identifiers, and/or beam specific information.

In various embodiments, the handover preparation process at S213 can be performed in a grouped manner (grouped signaling mechanism) or an ungrouped manner (separate signaling). In the ungrouped manner, signaling messages (handover request and handover request response) can be transmitted separately for each of the relay UE 202 and remote UEs (including the remote UE 201). In the grouped manner, the signaling messages for different relay or remote UEs can be combined into a single handover request message and a single handover request response message.

In various embodiments, the handover to be performed can be intra-RAT or inter-RAT. The source and target base stations involved can be connected to a same or different core networks. The different core networks can be of a same type or different types. For example, the core networks can be a fifth-generation core (5GC) or can be an evolved packet core (EPC).

At S214, an RRC reconfiguration message is transmitted from the source base station 203 to the remote UE 201 via the relay UE 202. For example, the transmission of the RRC reconfiguration message can be based on the L2 UE-to-network relay mechanism. The RRC reconfiguration message can pass through the relay UE 202 without the relay UE 202 decoding the content of the RRC reconfiguration message.

The RRC reconfiguration message can include a remote UE CHO configuration. The remote UE CHO configuration can include the configuration of the target base station 204 prepared by the target base station 204 at S213 for the remote UE 201. The remote UE CHO configuration can further include a CHO configuration execution (or application) condition. For example, the CHO configuration execution condition can be an arrival of a CHO trigger indication transmitted from the relay UE 202.

At S215, a response message can be transmitted from the remote UE 201 to the source base station 203 via the relay UE 202 to acknowledging the reception of the RRC configuration message at S214. The response message is referred to as an RRC reconfiguration complete message in an example. Similarly, the response message can be relayed by the relay UE 202 using the L2 UE-to-network relay mechanism. In an example, the step of S215 is skipped.

At S216, a handover command for the relay UE 202 can be transmitted from the source base station 203 to the relay UE 202. In an embodiment, the transmission of the handover command for the relay UE 202 can occur after the remote UE CHO configuration at S214 is transmitted. In case there is a group of remote UEs being relayed by the relay UE 202, the transmission of the handover command for the relay UE 202 can take place after remote UE CHO configurations for this group of remote UEs are transmitted.

The handover command for the relay UE 202 can be another RRC reconfiguration message. The handover command for the relay UE 202 can include the configuration of the target base station 204 prepared for the relay UE 202 at S213.

In an embodiment, the grouped signaling mechanism can be employed for signaling the configurations of the target base station 204 signaled at S214 and 5216. For example, instead of performing S214 and S216 separately, a grouped RRC message containing both the configurations of the target base station 204 signaled at S214 and S216 can be transmitted. The configuration of the target base station 204 for the remote UE 201 can be carried in a container of the grouped RRC message. The relay UE 202 can pick out the configuration from the container and forward the configuration to the remote UE 201. If multiple remote UEs are being served by the relay UE 202 for data relaying, multiple configurations of the target base station 204 for each remote UE can be carried in multiple containers or one container of the grouped RRC message.

In an embodiment, the transmission of the configuration of the target base station 204 for the remote UE 201 can be transmitted earlier, for example, before S211. For example, before the handover of the relay UE 202 is started at S211 (a trigger event happens), one or more target base stations can be predicted and prepared, resulting in configurations of the one or more target base stations for the remote UE 201. Those configurations of the one or more target base stations can be transmitted from the source base station 203 to the remote UE 201 via the relay UE 202. The signaling of a handover configuration in an earlier stage can be referred to as an early configuration method. In contrast, the one in a later stage can be referred to as a late configuration method. In other embodiments, the transmission of the configuration of the target base station 204 for the remote UE 201 can be transmitted at any time between S213 and S210.

At S217, a forwarding process for relaying between the remote UE 201 and the source base station 203 can be stopped. For example, in response to receiving the handover command at S216, the relay UE 202 may initiate a handover to switch to the target base station 204. For example, the relay UE 202 may apply (or execute) the configuration contained in the handover command. For example, the layers and/or sublayers in the protocol stack (such as RRC, SDAP, PDCP, adaptation, RLC, MAC, or PHY sublayers) can be reconfigured. New parameters can be applied to those layers and/or sublayers.

During the above switching process, communications between the relay UE 202 and the source base station 203 may stop on the Uu interface side. Communications (relaying or non-relaying) between the remote UE 201 and the relay UE 202 may continue on the PC5 interface side in an embodiment. For the relaying communications, the relaying data (for example, the relaying data transmitted from the remote UE 201 to the relay UE 202) may be buffered in a memory of the relay UE 202. In another embodiment, the relaying data may be dropped by the relay UE 202.

In an embodiment, the relay UE 202 is configured with a dual active protocol stack (DAPS). In such a case, the relay UE 202 may still maintain the communications with the source base station for relaying or non-relaying data while performing the handover.

At S218, a handover completion indication is transmitted from the relay UE 202 to the target base station 204, for example, after successfully establishing the connection between the relay UE 202 and target base station 204. The relay UE 202 may perform a random access using the configured random access channel (RACH) resources to establish a connection with the target base station 204. The relay UE 202 may transmit a handover complete message, for instance, an RRC reconfiguration complete message, to the target base station 204. In case the handover process triggered at S216 is failed, no handover completion indication is transmitted. In response to receiving the handover completion indication, the target base station 204 can coordinate with the source base station 203 and certain functional components within one or more core networks to switch one or more data paths from the source base station 203 to the target base station 204. As a result, data towards the relay UE 202 can be sent to the target base station 204.

At S219, a remote UE CHO trigger indication is transmitted from the relay UE 202 to the remote UE 201. In various embodiments, the CHO trigger indication can be signaled in various ways. In an embodiment, the CHO trigger indication is transmitted over a New Radio sidelink or an LTE sidelink. The CHO trigger indication is included in a sidelink RRC (for example, PCS RRC) message corresponding to an RRC layer terminated between the relay UE 202 and the remote UE 201. Other types or layers and/or sublayers of protocols for transmitting control messages may be employed in other examples.

In various embodiments, the transmission of the CHO trigger indication over the sidelink can be a broadcast transmission, a multicast transmission, or a unicast transmission, for example, depending on the sidelink configurations among a group of remote UEs and the relay UE 202. For example, in case there is a group of remote UEs being relayed by the relay UE 202, the CHO trigger indication can be broadcast or multicast to those remote UEs. Alternatively, a unicast mechanism can be employed for each remote UE.

In the FIG. 2 example, the CHO trigger indication is transmitted after the transmission of the handover completion indication at S218. Accordingly, the CHO trigger indication can indicate the completion of handover-related operations at the relay UE 202. In such a case, the CHO trigger indication can be referred to as a handover complete indication.

In other embodiments, the CHO trigger indication can be transmitted earlier than or at the same time as the transmission of the handover completion indication at S218. In such a case, the CHO trigger indication can be transmitted once the handover succeeds but before transmission of the handover completion message. For example, the success can be determined when a connection is established between the relay UE 202 and the target base station 204 in an example.

If the handover is failed, the relay UE 102 may try to establish a connection with a second target base station (if necessary configurations are provided). After the latest handover succeeds, the relay UE 202 can send an identifier (ID) of the last target base station along with the CHO trigger indication to the remote UE 201. This scenario assumes multiple configurations of candidate target base station have been provided to the remote UE 201 in advance (for example, as part of S214). This scenario can happen when the relay UE 202 is configured to perform a CHO with multiple candidate target base stations configured. It is noted that from the perspective of the remote UE 201, this scenario is not distinguishable from the scenario in which an original handover to the last target base station is successful. The remote UE 201 only sees the CHO trigger indication in S219 as an indication to perform handover to the corresponding target base station.

In another case, the transmission of the CHO trigger indication can be transmitted after the forwarding is stopped at S217. For example, if the transmission of the CHO trigger indication is transmitted earlier than S217, a CHO completion indication from the remote UE 201 can arrive at the relay UE 202 earlier than S217. This is possible because execution of the handover configuration at the remote UE 201 can only involve a small number of sublayers (such as PDCP sublayer) related with L2 relaying and thus be quick in some examples. Thus, transmission of the CHO trigger indication after the forwarding is stopped can avoid the CHO completion indication from the remote UE 201 being transmitted to the source base station 203.

Of course, the transmission of the CHO trigger indication can be immediately before the forwarding is stopped at S217 as long as the forwarding process has been stopped when the CHO completion indication arrives from the remote UE 201.

At S220a, the CHO at the remote UE 201 is triggered when the CHO trigger indication is received. As indicated by the CHO configuration at S214, the execution of the handover configuration at the remote UE 201 is conditioned on the arrival of the CHO trigger indication. Accordingly, the remote UE 201 can reconfigure a few upper protocol layers and/or sublayers based on the received handover configuration of the target base station 204 and become ready for communicating with the target base station 204 via the relay UE 202. The few upper protocol layers and/or sublayers can include SDAP and/or PDCP sublayers above RLC sublayer in an example.

At S220b, the relay UE 202 can resume the forwarding process after the connection to the target base station 204 is established. For example, data from the remote UE 201 or the target base station 204 (forwarded from the source base station 203 or received from a new data path) can be relayed by the relay UE 202. The step of S220b can be after sending the handover completion indication at S218 in an example. The step of S220b can be in parallel with the step of S220a in some examples.

At S221, a CHO completion indication can be transmitted from the remote UE 201 to the target base station 204 via the relay UE 202 after the step of S220a and S220b. Various relaying mechanisms can be employed for relaying the CHO completion indication, such as the L2 UE-to-network relay mechanism. In response to receiving the CHO completion indication, similarly, the target base station 204 can coordinate with the source base station 203 and certain functional components within one or more core networks to switch one or more data paths. As a result, data sent from the one or more core networks towards the remote UE 201 can be sent to the target base station 204. At this stage, the handovers of the relay UE 202 and the remote UE 201 are complete.

At S222, communications via the relay UE 202 between the remote UE 201 and the target base station 204 can start and be maintained. The process 200 can terminate after S222.

Assume the remote UE CHO mechanism is not employed. The CHO trigger indication at S219 is not transmitted. The remote UE 201 would immediately apply a newly received RRC reconfiguration at S214 and transmit a handover completion indication in response. The handover completion indication may arrive at the relay UE 202 earlier than the forwarding process being stopped at S217. To handle such a situation, one possible solution is to allow the handover completion indication to be relayed to the source base station 203. The source base station 203 may have to handle the handover completion indication, for example, by forwarding the handover completion indication to the target base station 204.

Or, with another solution, the relay UE 202 is configured with a mechanism to decode and hold the handover completion indication message until the forwarding is resumed at S220b. The mechanism can be, for example, based on a new design of a message format or a sublayer protocol. This mechanism may require the relay UE to identify the handover completion indication message even though the relay UE cannot read the contents of the handover completion message (for instance, because security for the handover completion message may be terminated between the remote UE and the target base station). Both the solutions have a high complexity for implementing the handover of a remote UE along with a relay UE in context of UE-to-network relay.

The remote UE CHO techniques or other techniques disclosed herein can effectively avoid the above complexities and provide a reliable and straightforward solution for handing over remote UEs together with a relay UE.

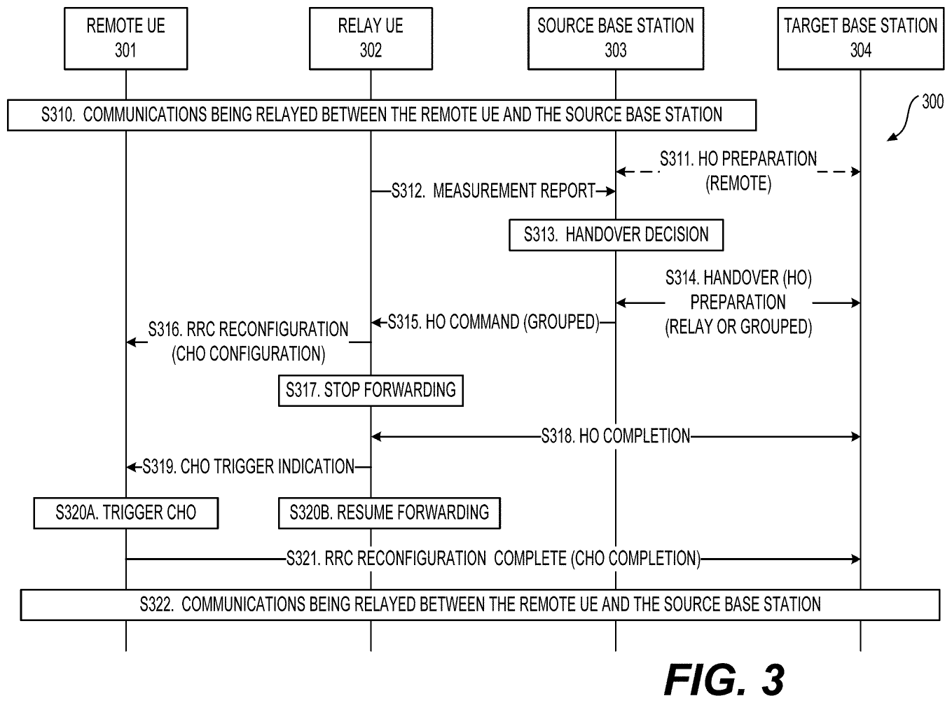

FIG. 3 shows another remote UE and relay UE handover process 300 according to an embodiment of the disclosure. During the process 300, a remote UE 301 and a relay UE 302 are handed over from a source base station 303 to a target base station 304. Similar to the process 200, the handover of the remote UE 301 is triggered by a CHO trigger indication received from the relay UE 302. Unlike the process 200, the process 300 employs grouped signaling for transmission at S315. The process 300 can start from S310.

The step of S310 can be similar to the step of S210 in the FIG. 2 example.

At S311, a handover preparation process for the remote UE 301 can be performed. For example, the source base station can predict the target base station 304 to be a target base station for handing over the remote UE 301 (and the relay UE 302). The prediction can be based on measurements reported (periodically or event-triggered, for example) from the relay UE 302. A configuration of the target base station 304 for the remote UE 301 can be prepared and received at the source base station 303. Alternatively, the operations at S311 can be moved to S314 and performed after a handover decision at S313.

The steps of S312 and S313 can be similar to the steps of S211 and S212 in the FIG. 2 example.

At S315, a grouped handover command can be signaled from the source base station 303 to the relay UE 302. In an example, the grouped handover command can be an RRC reconfiguration message comprising a container. The RRC reconfiguration message can include a configuration of the target base station 304 intended for the relay UE 302. The container may carry another RRC reconfiguration message intended for the remote UE 301. The RRC reconfiguration message in the container can include the remote UE CHO configuration. Similar to what is described in the process 200, the remote UE CHO configuration can include a configuration of the target base station 304 prepared for the remote UE 301 and an execution condition. The execution condition can be arrival of a CHO trigger indication at the remote UE 301.

At S316, the relay UE 302 can forward the RRC reconfiguration message in the container to the remote UE 301. On the other hand, based on the RRC reconfiguration message intended for the relay UE 302, a handover process can be triggered at the relay UE 302. For example, execution of the configuration of the target base station 304, random access, and transmission of a handover completion indication (S318) can subsequently be performed.

The steps of S317-S322 can be similar to the steps of S217-S222 in the FIG. 2 example. The process 300 can terminate after S322.

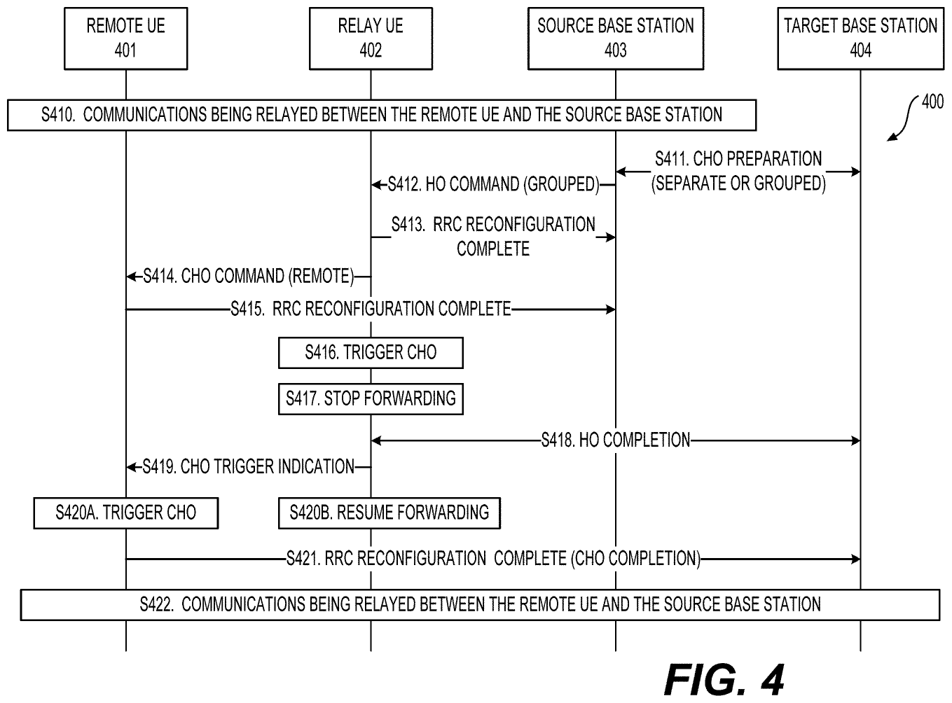

FIG. 4 shows another remote UE and relay UE handover process 400 according to an embodiment of the disclosure. During the process 400, a remote UE 401 and a relay UE 402 are handed over from a source base station 403 to a target base station 404. Similar to the processes 200/300, the handover of the remote CE 401 is triggered by a CHO trigger indication received from the relay UE 402. Similar to the process 300, the process 400 is shown to employ grouped signaling for transmission at S412. Different from the process 300, the handover performed by the relay UE 402 is a CHO. The process 400 can start from S410.

The step of S410 can be similar to the step of S310 in the FIG. 3 example.

At S411, a CHO preparation process can be performed. Although only one target base station 404 is shown in FIG. 4, multiple candidate target base stations can be involved in the CHO preparation process. The source base station 403 may select the candidate target base station(s) based on measurements reported from the relay UE 402 and/or other factors. In an embodiment, the source base station 403 can send one or more handover requests to each candidate target base station. In response, one or more of the candidate target base station(s) can prepare and feedback a handover configuration for each of the remote UE 401 and the relay UE 402. When there is a group of remote UEs served by the relay UE 402, one or more of the candidate target base station(s) can also prepare a handover configuration for each of the group of remote UEs.

The signaling between the source base station 403 and the candidate target base station(s) can be grouped or separate. For example, in the grouped manner, handover requests for the relay UE 402 and the remote UE 401 towards one candidate target base station can be combined into one request message. And, in response, handover request responses for the relay UE 402 and the remote UE 401 from the respective one candidate target base station can be combined into one handover request response message. When separate, requests for handovers of the relay UE 402 and the remote UE 401 to a same candidate target base station can be transmitted with separate request messages, and responses from the same candidate target base station can be transmitted with separate response messages.

At S412, a grouped CHO command is transmitted from the source base station 403 to the relay UE 402. In an embodiment, the grouped CHO command can include a first RRC reconfiguration message comprising a container. The container includes a second RRC reconfiguration message. The first and second RRC reconfiguration messages are destined for the relay UE 402 and the remote UE 401, respectively. The first RRC reconfiguration message can serve as a conditional handover command. The first RRC reconfiguration message can include the configuration(s) of the candidate target base station(s) (or candidate cells of those base stations) and one or more execution conditions corresponding to each candidate target base station. The second RRC reconfiguration message can include the configurations of the candidate target base stations (or candidate cells) and an execution condition. The execution condition in the second RRC reconfiguration message can be the arrival of a CHO trigger indication from the relay UE 402.

At S413, the relay UE 402 can decode the first RRC reconfiguration message and, in response, reply with a message (such as an RRC reconfiguration complete message) to acknowledge the reception of the first RRC reconfiguration message.

At S414, the relay UE 402 can forward the second RRC reconfiguration message to the remote UE 401. The forwarded second RRC reconfiguration message serves as a CHO command transmitted at S414.

At S415, a message for acknowledging the reception of the CHO command at S414 can be transmitted from the remote UE 401 to the source base station 403 via the relay UE 401. In the FIG. 4 example, the message is an RRC reconfiguration complete message.

At S416, the relay UE 402 may monitor in an ongoing fashion whether any execution condition in the first RRC reconfiguration message at S412 is fulfilled. When one execution condition is detected fulfilled, a candidate target base station associated with the fulfilled condition can be identified. The CHO of the relay UE 402 can be started to switch to the identified candidate target base station. For example, the configuration of this identified candidate base station can be applied at the relay UE 402.

At S417, a forwarding process can be stopped at the relay UE 402. No relay data comes from the source base station 403 anymore, since the relay UE 402 has triggered handover to move away from the source base station 403. Relay data from the remote UE 401 may arrive and be stored in a buffer of the relay UE 402 in an embodiment, or dropped by the relay UE 402 in another embodiment.

At S418, a handover completion indication can be transmitted from the relay UE 402 to the identified target base station. Random access to the identified candidate base station can be performed by the relay UE 402 in order to establish a connection to transmit the handover completion indication. The identified target base station is the target base station 404 in the FIG. 4 example. In an embodiment, the relay UE 402 can be configured to try more than one candidate target base station to hand over.

At S419, a CHO trigger indication is transmitted along with an ID of the identified target base station 404 (or an ID of an identified cell corresponding to the identified target base station 404). Because a UE in connection with a serving base station is operating within a cell of the serving base station, an ID of a base station can refer to an ID of a cell of the respective base station (either a source or a target base station) in the context of this disclosure. Similarly, parameters associated with a base station can refer to parameters associated with a cell of the respective base station depending on the context of the description.

At S420a, the CHO can be triggered at the remote UE 401. For example, the remote UE 401 can determine that the execution condition is satisfied based on the received CHO trigger indication. The remote UE 401 can identify a candidate configuration from the multiple candidate configurations of the candidate target base stations based on the received ID of the target cell or base station. The remote UE 401 may then apply the identified configuration and switch to the identified target base station 404.

At S420b, the relay UE 402 may resume the forwarding process after sending the handover completion at S418. At S421, a CHO completion indication (such as an RRC reconfiguration complete message) can be transmitted by the remote UE 401 via the relay UE 402 to the identified candidate target base station 404 after S420a and S420b. The step of S422 can be similar to the step of S322 in the FIG. 3 example. The process 400 can terminate after S421.

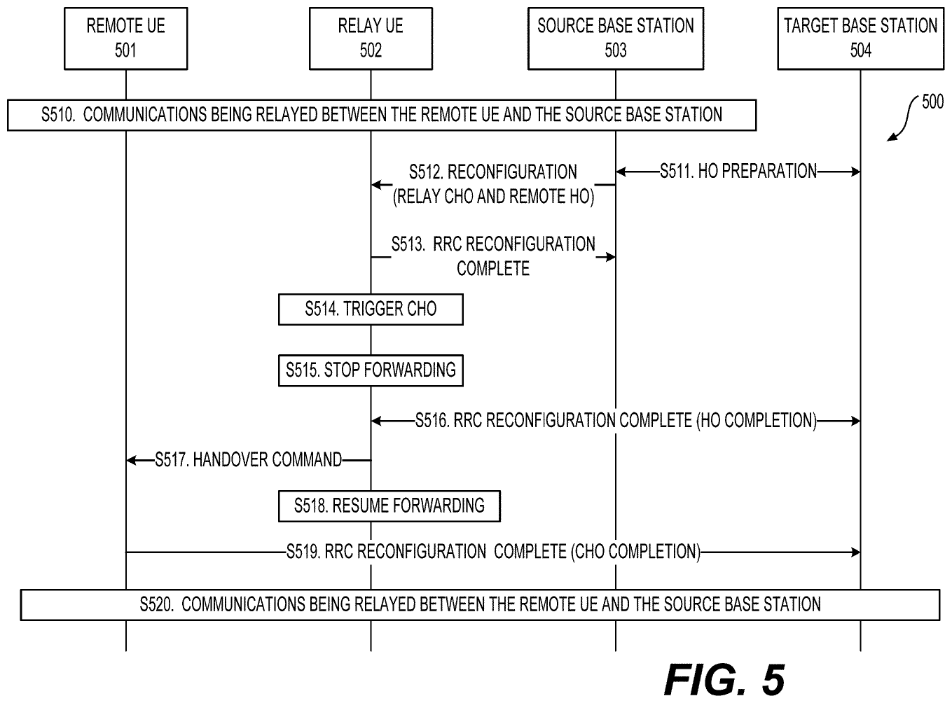

FIG. 5 shows another remote UE and relay UE handover process 500 according to an embodiment of the disclosure. During the process 500, a remote UE 501 and a relay UE 502 are handed over from a source base station 503 to a target base station 504. During the process 500, a CHO can first be triggered at the relay UE 502. At this moment, a candidate target base station (the target base station 504 in the FIG. 5 example) can become known for the handover of the relay UE 502 and the remote UE 501. The relay UE 502 can signal to the remote UE 501 a handover command including a configuration of the candidate target base station. At the remote UE 501, a handover can accordingly be triggered by the handover command. The process 500 can start from S510.

The step of S510 can be similar to S410 in the process 400.

At S511, a CHO preparation process can be performed. For example, the step of S511 can be similar to the step S411 in the process 400. The source base station 503 can interact with one or multiple candidate target base stations (including the target base station 504) in a grouped manner or separate manner to obtain configurations clone or more candidate cells of a respective candidate target base station for the remote UE 501 and the relay UE 502.

At S512, a handover reconfiguration message is transmitted from the source base station 503 to the relay UE 502. The handover reconfiguration message can include two portions. The first portion can comprise a CHO configuration for the relay UE 502. The CHO configuration for the relay UE 502 can include the configurations of the candidate cells generated by the candidate target base stations for the relay UE 502 and associated execution condition(s). The second portion can comprise a handover configuration for the remote UE 501. The handover configuration for the remote UE 501 can include the configurations of the candidate cells generated by the candidate target base stations for the remote UE 501. In an example, the handover reconfiguration message can be an RRC reconfiguration message comprising a container. The first portion is carried in the RRC reconfiguration message, while the second portion is carried in the container. The relay UE 502 may store the handover configuration for the remote UE 501. The relay UE 502 may store the handover configuration for the relay UE 502.

At S513, a message acknowledging reception of the handover reconfiguration message at S512 can be transmitted from the relay UE 502 to the source base station.

At S514, a CHO of the relay UE 502 can be triggered. For example, at S512, the relay UE 502 decodes the first portion (the CHO configuration) from the handover reconfiguration message received at S512 and accordingly monitors if any conditions specified in the CHO configuration is satisfied. For example, a condition associated with a candidate target cell can be a signal quality difference between a current serving cell of the source base station 503 and the candidate target cell being above a threshold. By monitoring measurements of signal qualities of neighbor cells and the serving cell, the relay UE 502 can determine when the condition is satisfied. The monitoring starts from S512 and continues until a trigger is detected causing S514 to be initiated.

When the condition is determined to be satisfied, the relay UE 502 can start the CHO using the CHO configuration for the relay UE 502 generated by the candidate target cell (the cell of the target base station 504 in the FIG. 5 example). For example, parameters in the configuration can be applied to layers and/or sublayers of respective protocol stacks.

At S515, a forwarding process can be stopped for relaying data between the remote UE 501 and the source base station 503 when the CHO is triggered at S514.

At S516, a handover completion message can be transmitted from the relay UE 502 to the target base station 504. The relay UE 502 may perform random access on a cell of the target base station 504 in order to establish a connection for transmitting the handover completion message. In an embodiment, the handover completion message is an RRC reconfiguration complete message.

At S517, a handover command can be transmitted from the relay UE 502 to the remote UE 501 to trigger a handover of the remote UE 501. The handover command may comprise all or part of a configuration for the remote UE 501 that was previously stored at S512. For example, after the CHO is triggered at S514, a candidate target cell (or base station) for handing over the relay UE 502 may become known to the relay UE 502. Based on information of the known candidate target base station (for example, an ID of the candidate target cell or an ID of the candidate target base station 504), the relay UE 502 can pick out the configuration of the known candidate target cell or base station from the configurations of the multiple candidate target cells or base stations in the second portion of the message transmitted at S512. The picked out configuration can be carried in the handover command destined for the remote UE 501.

In response to receiving the handover command, the remote UE 501 can start to apply the received configuration in the handover command.

At S518, the forwarding process can be resumed with protocol sublayers at the relay UE 502 have been reconfigured based on the respective handover configurations and the connection to the target base station 504 can been established. The S518 can occur after or before S517 in different examples.

At S519, a handover completion indication can be transmitted from the remote UE 501 to the target base station 504 via the relay UE 502. For example, the L2 UE-to-network relay mechanism can be employed for relaying the handover completion indication. In an embodiment, the handover completion indication is carried in an RRC reconfiguration complete message.

At S520, the handover of the remote UE 501 and the relay UE 502 to the target base station 504 is completed. The communication between the remote UE 501 and the target base station 504, relayed via the relay UE 502, is being maintained. The process 500 can terminate after S520.

While the transmission of the handover command at S517 is shown to be performed after S516 where the handover completion indication of the relay UE 502 is transmitted, the step of S517 can be performed at other timings based on similar reasons discussed above in other embodiments. For example, the handover command can be transmitted after S515 (stop forwarding) and before S516 (sending handover completion indication) in an example. Or, the handover command can be transmitted before S515 (stop forwarding) and after S514 (triggering the relay UE CHO) in another example.

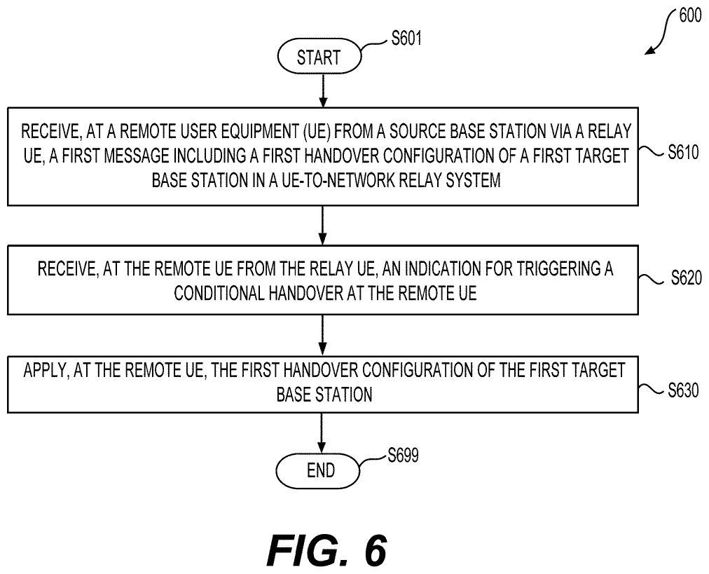

FIG. 6 shows a handover process 600 according to an embodiment of the disclosure. The handover process 600 can be performed by a remote UE in a UE-to-network relay system. The process can start from S601 and proceed to S610.

At S610, a first message can be received at the remote UE from a source base station via a relay UE in the UE-to-network relay system. The first message can include a first handover configuration of a first target base station for the remote UE in the UE-to-network relay system. The first message can further include a condition for triggering the conditional handover at the remote UE. The condition can be the reception of an indication for triggering the conditional handover at the remote UE.

At S620, the indication for triggering a conditional handover at the remote UE can be received at the remote UE from the relay UE. In an example, the indication for triggering the conditional handover at the remote UE is transmitted from the relay UE after the relay UE transmits an indication of handover completion of the relay UE to the first target base station. In an embodiment, the remote UE can transmit to the source base station via the relay UE a message acknowledging the reception of the first message.

At S630, the first handover configuration of the first target base station can be applied at the remote UE in response to the reception of the indication for triggering the conditional handover at the remote UE. For example, the remote UE can determine the condition for triggering the conditional handover at the remote UE is satisfied based on the reception of the indication for triggering the conditional handover at the remote UE. After the first handover configuration of the first target base station is applied, the remote UE can transmit to the first target base station via the relay UE a second message including an indication of handover completion by the remote UE.

In an embodiment, the first message includes a plurality of handover configurations each associated with one of a plurality of target base stations including the first target base station. The remote UE can receive from the relay UE an indication of which one of the plurality of handover configurations is to be applied for the conditional handover at the remote UE accompanying or after the indication for triggering the conditional handover at the remote UE. In an example, the indication of which one of the plurality of handover configurations is to be applied for the conditional handover at the remote UE includes an identifier corresponding to a cell of the first target base station. The process 600 can proceed to S699 and terminate at S699.

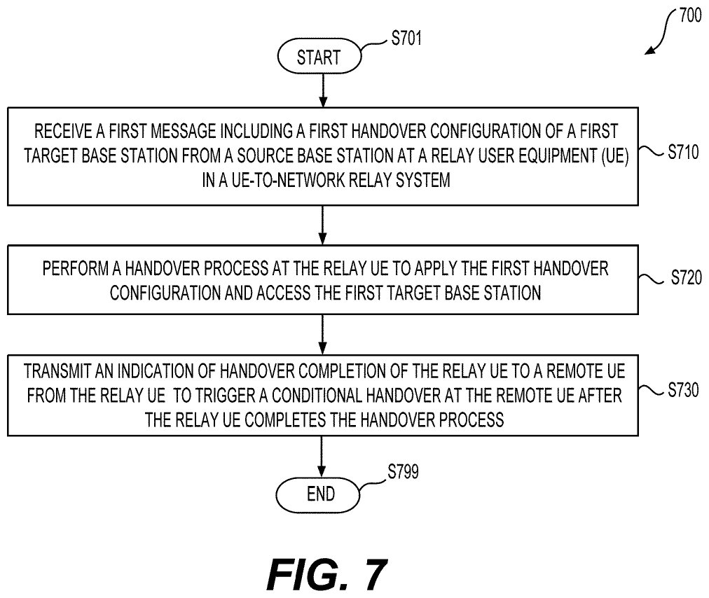

FIG. 7 shows a handover process 700 according to an embodiment of the disclosure. The handover process 700 can be performed by a relay UE in a UE-to-network relay system. The process can start from S701 and proceed to S710.

At S710, a first message including a first handover configuration of a first target base station can be received from a source base station at a relay UE in a UE-to-network relay system.

In an example, the relay UE relays from the source base station to the remote UE a second message including a second handover configuration of the first target base station for the remote UE. The second message further includes a condition for triggering the conditional handover at the remote UE. The condition can be a reception of the indication of handover completion of the relay UE at the remote UE.

In an example, the relay UE receives the first message including the first handover configuration of the first target base station for the relay UE after the relay of the second message including the second handover configuration of the first target base station. In another example, the relay UE receives a grouped handover command from the source base station. The grouped handover command includes the first message including the first handover configuration of the first target base station for the relay UE and the second message including the second handover configuration of the first target base station for the remote UE.

In an example, the relay UE receives a conditional handover command in the first message from the source base station. The conditional handover command includes a plurality of third handover configurations including the first handover configuration of the first target base station for the relay UE. The plurality of third handover configurations each correspond to one of a plurality of candidate target base stations including the first target base station. The plurality of third handover configurations each are associated with one or more conditions for triggering the relay UE to apply the respective third handover configuration. The second message includes a plurality of fourth handover configurations each corresponding to one of the plurality of candidate target base stations. The plurality of fourth handover configurations includes the second handover configuration of the first target base station for the remote UE.

At S720, a handover process can be performed at the relay UE to apply the first handover configuration and access the first target base station. After a connection is established between the relay UE and the first target base station, the relay UE can transmit an indication of handover completion of the relay UE to the first target base station.

In an example, the handover process of the relay UE is triggered by the reception of the first handover configuration of the first target base station from the source base station. In another example, the first message further includes a first execution condition associated with the first handover configuration of the first target base station. The handover process of the relay UE is a conditional handover that is triggered when the relay UE determines that the first execution condition has been satisfied.

The relay UE may stop a forwarding process for relayed communications between the remote UE and the source base station when the handover process to apply the first handover configuration and access the first target base station is triggered. The relay UE may resume the forwarding process for relayed communications between the remote UE and the source base station when the relay UE completes the handover process. Completion of the handover process by the relay UE can be represented by the establishment of the connection between the relay UE and the first target base station or the transmission of the indication of handover completion of the relay UE to the first target base station.

At S730, an indication of handover completion of the relay UE can be transmitted to a remote UE from the relay UE to trigger a conditional handover at the remote UE after the relay UE completes the handover process. In an example, the indication of handover completion of the relay UE is transmitted from the relay UE after the relay UE transmits the indication of handover completion of the relay UE to the first target base station.

In case the handover process is the conditional handover, the relay UE can further transmit to the remote UE an indication of which cell or base station the relay UE is handed over to. The indication of which cell or base station the relay UE is handed over to and the indication of handover completion of the relay UE can be included in a same message or different messages.

In an example, the relay UE relays from the remote UE to the first target base station a third message including an indication of handover completion of the remote UE based on the second handover configuration of the first target base station. The process 700 can proceed to S799 and terminate at S799.

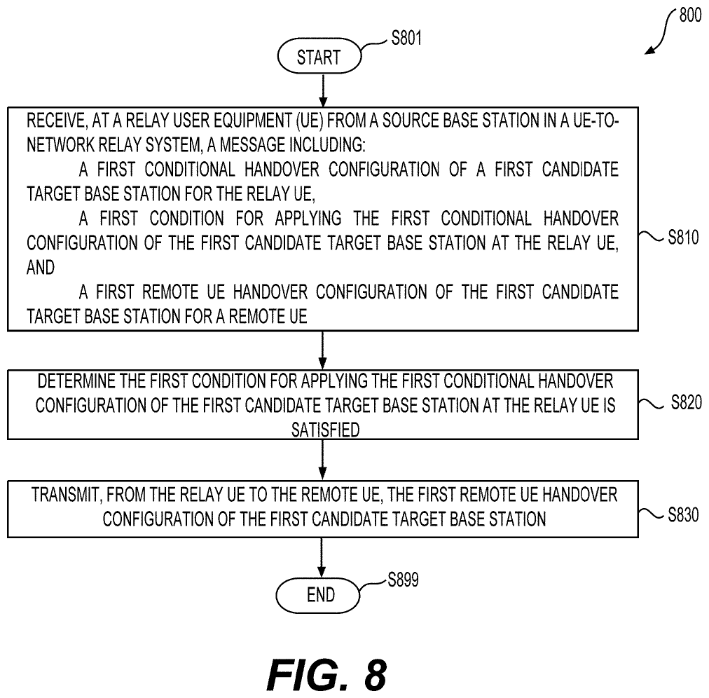

FIG. 8 shows a handover process 800 according to an embodiment of the disclosure. The handover process 800 can be performed by a relay UE in a UE-to-network relay system. The process can start from S801 and proceed to S810.

At S810, the relay UE can receive a message from a source base station in the UE-to-network relay system. The message can include a first conditional handover configuration of a first candidate target base station for the relay UE, a first condition for applying the first conditional handover configuration of the first candidate target base station at the relay UE, and a first remote UE handover configuration of the first candidate target base station for a remote UE. In an example, the first remote UE handover configuration of the first candidate target base station for the remote UE is carried in a container field of the received message.

At S820, the first condition for applying the first conditional handover configuration of the first candidate target base station at the relay UE can be determined to be satisfied. In an example, the relay UE can subsequently stop a forwarding process between the remote UE and the source base station. In an example, the relay UE can apply the first conditional handover configuration of the first candidate target base station, perform random access to the first candidate target base station, and transmit to the first candidate target base station an indication of a conditional handover being completed by the relay UE.

At S830, the first remote UE handover configuration of the first candidate target base station can be transmitted from the relay UE to the remote UE. Thereafter, an indication of handover completion can be received from the remote UE and relayed by the relay UE to the first candidate target base station.

In an example, the transmission of the first remote UE handover configuration of the first candidate target base station is performed after the forwarding process between the remote UE and the source base station being stopped. In an example, the transmission of the first remote UE handover configuration of the first candidate target base station is performed after the transmission of the indication of the conditional handover being completed by the relay UE.

In an embodiment, the message at S810 can include a plurality of conditional handover configurations each corresponding to one of a plurality of candidate target base stations for the relay UE. The plurality of conditional handover configurations can include the first conditional handover configuration. The plurality of candidate target base stations can include the first candidate target base station.

The message at S810 can further include a plurality of conditions each for applying a respective one of the plurality of conditional handover configuration at the relay UE. The plurality of conditions can include the first condition for applying the first conditional handover configuration of the first candidate target base station at the relay UE.

The message at S810 can further include a plurality of remote UE handover configurations each corresponding to one of the plurality of candidate target base stations for the remote UE. The plurality of remote UE handover configurations can include the first remote UE handover configuration.

Corresponding to receiving the first message, the first remote UE handover configuration at S810 can be identified from the plurality of remote UE handover configurations based on a cell ID corresponding to the first candidate target base station, after the first condition for applying the first conditional handover configuration of the first candidate target base station at the relay UE being determined to be satisfied. The process 800 can proceed to S899 and terminate at S899.

It is noted that, while the processes disclosed herein include steps that are performed in an order, those steps can be skipped, reordered, in parallel, or combined in respective processes in other embodiments.

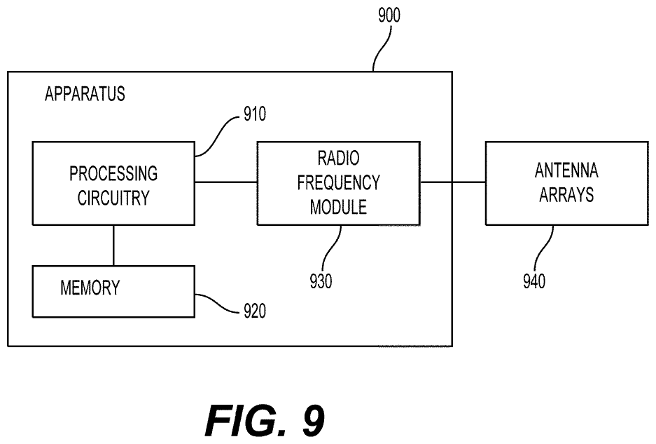

FIG. 9 shows an exemplary apparatus 900 according to embodiments of the disclosure. The apparatus 900 can be configured to perform various functions in accordance with one or more embodiments or examples described herein. Thus, the apparatus 900 can provide means for implementation of mechanisms, techniques, processes, functions, components, systems described herein. For example, the apparatus 900 can be used to implement functions of UEs or base stations in various embodiments and examples described herein. The apparatus 900 can include a general purpose processor or specially designed circuits to implement various functions, components, or processes described herein in various embodiments. The apparatus 900 can include processing circuitry 910, a memory 920, and a radio frequency (RF) module 930.

In various examples, the processing circuitry 910 can include circuitry configured to perform the functions and processes described herein in combination with software or without software. In various examples, the processing circuitry 910 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 910 can be a central processing unit (CPU) configured to execute program instructions to perform various functions and processes described herein. Accordingly, the memory 920 can be configured to store program instructions. The processing circuitry 910, when executing the program instructions, can perform the functions and processes. The memory 920 can further store other programs or data, such as operating systems, application programs, and the like. The memory 920 can include non-transitory storage media, such as a read-only memory (ROM), a random access memory (RAM), a flash memory, a solid-state memory, a hard disk drive, an optical disk drive, and the like.

In an embodiment, the RF module 930 receives a processed data signal from the processing circuitry 910 and converts the data signal to beamforming wireless signals that are then transmitted via antenna arrays 940, or vice versa. The RF module 930 can include a digital to analog converter (DAC), an analog to digital converter (ADC), a frequency up converter, a frequency down converter, filters and amplifiers for reception and transmission operations. The RF module 930 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 940 can include one or more antenna arrays.

The apparatus 900 can optionally include other components, such as input and output devices, additional or signal processing circuitry, and the like. Accordingly, the apparatus 900 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non- transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving, at a remote user equipment (UE) from a source base station via a relay UE, a first message including a first handover configuration of a first target base station in a UE-to-network relay system;
receiving, at the remote UE from the relay UE, an indication for triggering a conditional handover at the remote UE; and
applying, at the remote UE, the first handover configuration of the first target base station in response to the reception of the indication for triggering the conditional handover at the remote UE.

2. The method of claim 1, wherein the first message further includes a condition for triggering the conditional handover at the remote UE, the condition being the reception of the indication for triggering the conditional handover at the remote UE.

3. The method of claim 2, further comprising:
determining the condition for triggering the conditional handover at the remote UE is satisfied based on the reception of the indication for triggering the conditional handover at the remote UE.

4. The method of claim 1, wherein the indication for triggering the conditional handover at the remote UE is transmitted from the relay UE after the relay UE transmits an indication of handover completion of the relay UE to the first target base station.

5. The method of claim 1, further comprising:
transmitting, from the remote UE to the first target base station via the relay UE, a second message including an indication of handover completion by the remote UE.

6. The method of claim 1, further comprising:
transmitting, from the remote UE to the source base station via the relay UE, a third message acknowledging the reception of the first message.

7. The method of claim 1, wherein the indication for triggering the conditional handover at the remote UE is via a broadcast transmission, a multicast transmission, or a unicast transmission from the relay UE.

8. The method of claim 1, wherein the first message includes a plurality of handover configurations each associated with one of a plurality of target base stations including the first target base station.

9. The method of claim 8, further comprising:
receiving, from the relay UE, an indication of which one of the plurality of handover configurations is to be applied for the conditional handover at the remote UE.

10. The method of claim 9, wherein the indication of which one of the plurality of handover configurations is to be applied for the conditional handover at the remote UE includes an identifier corresponding to a cell of the first target base station.

11. A method, comprising:
receiving a first message including a first handover configuration of a first target base station from a source base station at a relay user equipment (UE) in a UE-to-network relay system;
performing a handover process at the relay UE to apply the first handover configuration and access the first target base station; and
transmitting an indication of handover completion of the relay UE to a remote UE from the relay UE to trigger a conditional handover at the remote UE after the relay UE completes the handover process.

12. The method of claim 11, wherein the indication of handover completion of the relay UE is transmitted from the relay UE after the relay UE transmits an indication of handover completion of the relay UE to the first target base station.

13. The method of claim 11, wherein the handover process of the relay UE is triggered by the reception of the first handover configuration of the first target base station from the source base station.

14. The method of claim 11, wherein the first message further include a first execution condition associated with the first handover configuration of the first target base station, and the handover process of the relay UE is a conditional handover that is triggered when the relay UE determines that the first execution condition has been satisfied.

15. The method of claim 14, further comprising:
transmitting, to the remote UE, an indication of which cell or base station the relay UE is handed over to.

16. The method of claim 11, further comprising:
stopping a forwarding process for relayed communications between the remote UE and the source base station when the handover process to apply the first handover configuration and access the first target base station is triggered; and
resuming the forwarding process for relayed communications between the remote UE and the source base station when the relay UE completes the handover process.

17. The method of claim 11, further comprising:
relaying, at the relay UE from the source base station to the remote UE, a second message including a second handover configuration of the first target base station for the remote UE; and
relaying, at the relay UE from the remote UE to the first target base station, a third message including an indication of handover completion of the remote UE based on the second handover configuration of the first target base station.

18. The method of claim 17, wherein the second message further includes a condition for triggering the conditional handover at the remote UE, the condition being a reception of the indication of handover completion of the relay UE at the remote UE.

19. The method of claim 17, wherein the relay UE receives the first message including the first handover configuration of the first target base station for the relay UE after the relay of the second message including the second handover configuration of the first target base station.

20. The method of claim 17, further comprising:
receiving a grouped handover command from the source base station, the grouped handover command including:
the first message including the first handover configuration of the first target base station for the relay UE, and
the second message including the second handover configuration of the first target base station for the remote UE.

21. The method of claim 17, further comprising:
receiving a conditional handover command in the first message from the source base station at the relay UE, the conditional handover command including a plurality of third handover configurations including the first handover configuration of the first target base station for the relay UE, the plurality of third handover configurations each corresponding to one of a plurality of candidate target base stations including the first target base station, the plurality of third handover configurations each associated with one or more conditions for triggering the relay UE to apply the respective third handover configuration,
wherein the second message includes a plurality of fourth handover configurations each corresponding to one of the plurality of candidate target base stations, the plurality of fourth handover configurations including the second handover configuration of the first target base station for the remote UE.

22. The method of claim 21, further comprising:
determining, at the relay UE, one of the one or more conditions associated with one of the plurality of third handover configurations corresponding to the first target base station is satisfied; and
transmitting, to the remote UE, an indication indicating that, among the plurality of fourth handover configurations, the fourth handover configuration corresponding to the first target base station is to be applied for the conditional handover at the remote UE.

23. A method, comprising:
receiving, at a relay user equipment (UE) from a source base station in a UE-to-network relay system, a message including:
a first conditional handover configuration of a first candidate target base station for the relay UE,
a first condition for applying the first conditional handover configuration of the first candidate target base station at the relay UE, and
a first remote UE handover configuration of the first candidate target base station for a remote UE;
determining the first condition for applying the first conditional handover configuration of the first candidate target base station at the relay UE is satisfied; and
transmitting, from the relay UE to the remote UE, the first remote UE handover configuration of the first candidate target base station.

24. The method of claim 23, further comprising:
stopping, subsequent to the determination of the first condition for applying the first conditional handover configuration of the first candidate target base station at the relay UE being satisfied, a forwarding process between the remote UE and the source base station,
wherein the transmission of the first remote UE handover configuration of the first candidate target base station is performed after the forwarding process between the remote UE and the source base station being stopped.

25. The method of claim 23, further comprising:
transmitting, from the relay UE to the first candidate target base station, an indication of a conditional handover being completed by the relay UE,
wherein the transmission of the first remote UE handover configuration of the first candidate target base station is performed after the transmission of the indication of the conditional handover being completed by the relay UE.

26. The method of claim 23, wherein the first remote UE handover configuration of the first candidate target base station for the remote UE is carried in a container field of the received message.

27. The method of claim 23, further comprising:
relaying an indication of handover completion from the remote UE to the first candidate target base station.

28. The method of claim 23, wherein the message includes:
a plurality of conditional handover configurations each corresponding to one of a plurality of candidate target base stations for the relay UE, the plurality of conditional handover configurations including the first conditional handover configuration, the plurality of candidate target base stations including the first candidate target base station,
a plurality of conditions each for applying a respective one of the plurality of conditional handover configuration at the relay UE, the plurality of conditions including the first condition for applying the first conditional handover configuration of the first candidate target base station at the relay UE, and
a plurality of remote UE handover configurations each corresponding to one of the plurality of candidate target base stations for the remote UE, the plurality of remote UE handover configurations including the first remote UE handover configuration.

29. The method of claim 23, further comprising:
identifying the first remote UE handover configuration from the plurality of remote UE handover configurations based on a cell ID corresponding to the first candidate target base station, the first condition for applying the first conditional handover configuration of the first candidate target base station at the relay UE being determined to be satisfied.
